(19) United States
(12) Patent Application Publication
(10) Pub. No.: US 2026/0341983 A1
(43) Pub. Date: Oct. 29, 2026

(54) ELECTRICAL CONDUCTOR SPLICE DEVICES HAVING CONDUCTOR JAWS WITH REMOVAL TABS

(71) Applicant: HUBBELL INCORPORATED, Shelton, CT (US)

(72) Inventors: Spencer Phelan Ralphs, Stoneham, MA (US); Jefferson Robert Hall, Concord, NH (US); Gary Edward Schrader, Manchester, NH (US)

(73) Assignee: HUBBELL INCORPORATED, Shelton, CT (US)

(21) Appl. No.: 19/653,665

(22) Filed: Apr. 21, 2026

Related U.S. Application Data
(60) Provisional application No. 63/793,984, filed on Apr. 24, 2025.

(51) Int. Cl. H01R 4/48; H01R 4/44; H02G 1/14

(52) U.S. Cl. CPC H01R 4/4872; H01R 4/44; H02G 1/14

(57) ABSTRACT

An electrical conductor splice device has a housing with a hub and a leg. The leg depends outward from the hub along a conductor axis. A set of jaws is configured to receive an electrical conductor and positioned in the leg. A cover encloses a portion of the set of jaws. A tab depends from at least one jaw. A movement conversion assembly disposed in the hub includes a driver. The movement conversion assembly is operatively associated with the set of jaws to convert a tightening movement of the driver into a linear outward movement of the set of jaws along the conductor axis. An inner surface of the leg interacts with an outer surface of the set of jaws to convert the linear outward movement into a clamping movement to impart a clamping force on the electrical conductor to mechanically and electrically connect the electrical conductor.

### CROSS-REFERENCE TO RELATED APPLICATIONS

This application claims the benefit of U.S. Provisional Application No. 63/793,984, filed on Apr. 24, 2025, the entire disclosure of which is incorporated herein by reference.

### BACKGROUND

### 1. Field of the Disclosure

The present disclosure is related to splice devices for electrical conductors. More particularly, the present disclosure relates to splice devices that quickly connect electrical conductors of the same or different outer diameters, and, more particularly, without the need for special tools. The present disclosure is further related to such splice devices having a conductor jaw with a removal tab.

### 2. Description of Related Art

Automatic splice devices are known and have been found to be an economically attractive option for splicing electrical conductors. These automatic splice devices allow the connection of electrical conductors without specialized tools. An example of such an automatic splice device is shown in Applicant's own U.S. Pat. No. 10,498,052.

However, such automatic splice devices can only form reliable electrical connections when a predetermined minimum tension is maintained on the conductors at all times. Simply stated, automatic splice devices cannot be used in “slack-span” applications, i.e., applications where little or no tension is applied to the conductors being joined. Moreover, automatic splice devices cannot reliably be used in applications where the predetermined minimum tension cannot be maintained due to vibration, wind, or other tension-relieving conditions.

Conversely, splice devices are known for such slack-span applications. However, some require specialized tools such as, but not limited to, crimping tools, and the like. Some also require multiple components, which increases the time and cost of splicing electrical conductors. Some have two sets of jaws that move within a tapered body to grip the conductor, but it is difficult, if not impossible, to remove the conductor from the splice after insertion. Often, an installer must cut the conductor at both ends of the splice entrance if the splice needs to be removed or adjusted, which is time-consuming.

Accordingly, it has been determined by the present application that there is a need for electrical conductor splicing devices that overcome, alleviate, and/or mitigate one or more of the aforementioned and other deleterious effects of the prior art.

### SUMMARY

An electrical conductor splice device is provided.

In one aspect, the electrical conductor splice device has a main housing with a hub and a first leg. The first leg depends outward from the hub along a conductor axis. A first set of jaws is positioned in the first leg. The first set of jaws is configured to receive a first electrical conductor. A first cover is disposed around the first leg to enclose a portion of the first set of jaws. A first tab depends from at least one jaw of the first set of jaws. A movement conversion assembly is disposed in the hub and includes a driver. The movement conversion assembly is operatively associated with the first set of jaws to convert a tightening movement of the driver into a linear outward movement of the first set of jaws along the conductor axis. The first leg has an inner surface that interacts with an outer surface of the first set of jaws to convert the linear outward movement of the first set of jaws into a clamping movement to impart a first clamping force on the first electrical conductor to mechanically and electrically connect the first electrical conductor. The first tab is uncovered by the first cover during the linear outward movement. The first tab is sized and shaped to allow a user to grasp it and move the first set of jaws so as to release the first clamping force.

In another aspect, the electrical conductor splice device includes a housing having a hub and a leg, a set of jaws disposed in the leg for receiving an electrical conductor, and a movement conversion assembly disposed in the hub and operatively associated with the set of jaws such that tightening of a driver causes the set of jaws to move away from the hub along a conductor axis and engage the electrical conductor with a clamping force, the set of jaws including a tab that projects from at least one of the jaws and defines a protruding structure sized and positioned to be grasped by a user while the clamping force is applied, such that application of a force to the tab enables movement of the at least one jaw toward the hub to reduce the clamping force and release the electrical conductor.

In some embodiments, either alone or together with any one or more of the aforementioned and/or after-mentioned embodiments, the tightening movement is a rotary movement of the driver about a driver axis or a linear movement of the driver along the driver axis.

In some embodiments, either alone or together with any one or more of the aforementioned and/or after-mentioned embodiments, the movement conversion assembly has a driving wedge and a first ram that are configured to convert the tightening movement into the linear outward movement of the first ram along the conductor axis. The linear outward movement of the first ram along the conductor axis results in a linear outward movement of the first set of jaws.

In some embodiments, either alone or together with any one or more of the aforementioned and/or after-mentioned embodiments, a first biasing member is positioned between the first ram and the first set of jaws.

In some embodiments, either alone or together with any one or more of the aforementioned and/or after-mentioned embodiments, the first biasing member is configured to provide an initial clamping force on the first set of jaws prior to the tightening movement.

In some embodiments, either alone or together with any one or more of the aforementioned and/or after-mentioned embodiments, the set of jaws is biased toward a default position, and application of a force to the tab causes the at least one jaw to move against a biasing force so as to reduce the clamping force on the electrical conductor.

In some embodiments, either alone or together with any one or more of the aforementioned and/or after-mentioned embodiments, the movement conversion assembly is configured to mechanically and electrically connect the first conductor when the first conductor is under tension or not under tension.

In some embodiments, either alone or together with any one or more of the aforementioned and/or after-mentioned embodiments, the driver further includes a torque-limiting area that shears off a portion of the driver at a desired torque to ensure the clamping force has been applied to the first electrical conductor.

In some embodiments, either alone or together with any one or more of the aforementioned and/or after-mentioned embodiments, the main housing further has a second leg depending outward from the hub along the conductor axis.

In some embodiments, either alone or together with any one or more of the aforementioned and/or after-mentioned embodiments, a second set of jaws is positioned in the second leg. The second set of jaws is configured to receive a second electrical conductor. A second cover is disposed around the second leg to enclose a portion of the second set of jaws. A second tab depends from at least one jaw of the second set of jaws. The movement conversion assembly is operatively associated with the second set of jaws to convert the tightening movement of the driver into the linear outward movement of the second set of jaws along the conductor axis. The second leg has an inner surface that engages the outer surface of the second set of jaws to convert the linear outward movement of the second set of jaws into a clamping movement that imparts a second clamping force on the second electrical conductor, thereby mechanically and electrically connecting the second electrical conductor. The second tab is uncovered by the second cover during the linear outward movement. The second tab is sized and shaped to allow a user to grasp it and thereby move the second set of jaws to release the second clamping force.

In some embodiments, either alone or together with any one or more of the aforementioned and/or after-mentioned embodiments, the movement conversion assembly is configured to move along the conductor axis during the tightening movement of the driver so as to accommodate differences in diameter of the first and second electrical conductors.

In some embodiments, either alone or together with any one or more of the aforementioned and/or after-mentioned embodiments, the first and second sets of jaws move along the conductor axis independent of one another or in unison.

In some embodiments, either alone or together with any one or more of the aforementioned and/or after-mentioned embodiments, the movement conversion assembly has a driving wedge, a first ram, and a second ram that are configured to convert the tightening movement into the linear outward movement of the first and second rams along the conductor axis. The linear outward movement of the first and second rams along the conductor axis results in a linear outward movement of the first and second sets of jaws, respectively.

In some embodiments, either alone or together with any one or more of the aforementioned and/or after-mentioned embodiments, a first biasing member is positioned between the first ram and the first set of jaws. A second biasing member is positioned between the second ram and the second set of jaws.

In some embodiments, either alone or together with any one or more of the aforementioned and/or after-mentioned embodiments, the first and second biasing members are configured to provide an initial clamping force on the first and second sets of jaws prior to the tightening movement.

In some embodiments, either alone or together with any one or more of the aforementioned and/or after-mentioned embodiments, the movement conversion assembly is configured to mechanically and electrically connect the first and second conductors when the first and second conductors have a common outer diameter or different outer diameters.

In some embodiments, either alone or together with any one or more of the aforementioned and/or after-mentioned embodiments, the movement conversion assembly is configured to mechanically and electrically connect the first and second conductors when the first and second conductors are under tension or are not under tension.

In some embodiments, either alone or together with any one or more of the aforementioned and/or after-mentioned embodiments, the driver further includes a torque limiting area that shears off a portion of the driver at a desired torque to ensure the clamping force has been applied to the first and second electrical conductors.

In some embodiments, either alone or together with any one or more of the aforementioned and/or after-mentioned embodiments, the first set of jaws includes a first window that provides a visual confirmation of a position of the first electrical conductor within the first set of jaws.

In some embodiments, either alone or together with any one or more of the aforementioned and/or after-mentioned embodiments, the first set of jaws includes a first conductor stop that provides a tactile indication of a position of the first electrical conductor within the first set of jaws.

In some embodiments, either alone or together with any one or more of the aforementioned and/or after-mentioned embodiments, the first cover is retained on the first leg by a ridge disposed at an end of the first leg.

An electrical conductor splice device is provided. The device has a main housing with a hub and a first leg. The first leg depends outward from the hub along a conductor axis. A first set of jaws is positioned in the first leg. The first set of jaws is configured to receive a first electrical conductor. A first tab depends from at least one jaw of the first set of jaws. A movement conversion assembly disposed within the hub includes a driver. The movement conversion assembly is operatively associated with the first set of jaws to convert a tightening movement of the driver into a linear outward movement of the first set of jaws along the conductor axis, thereby imparting a first clamping force on the first electrical conductor to mechanically and electrically connect the first electrical conductor. The first tab is uncovered during the linear outward movement and is sized and positioned to allow a user to grasp it and move the first set of jaws to release the first clamping force.

In some embodiments, either alone or together with any one or more of the aforementioned and/or after-mentioned embodiments, the first tab depends from the at least one jaw in a direction perpendicular to the conductor axis.

In some embodiments, either alone or together with any one or more of the aforementioned and/or after-mentioned embodiments, the first tab depends from a rear surface of the at least one jaw.

In some embodiments, either alone or together with any one or more of the aforementioned and/or after-mentioned embodiments, the first tab depends from a side surface of the at least one jaw and does not surround and/or contact the first leg.

In some embodiments, either alone or together with any one or more of the aforementioned and/or after-mentioned embodiments, the first set of jaws has synchronization features configured to operatively connect each jaw of the first set of jaws to one another so as to move in unison along the conductor axis.

In some embodiments, either alone or together with any one or more of the aforementioned and/or after-mentioned embodiments, the first tab depends from one of the synchronization features.

In some embodiments, either alone or together with any one or more of the aforementioned and/or after-mentioned embodiments, the first tab is T-shaped, L-shaped, or linear.

In some embodiments, either alone or together with any one or more of the aforementioned and/or after-mentioned embodiments, a cover is disposed around the leg to enclose a portion of the set of jaws while the tab is not enclosed by the cover and extends clear of the cover to permit unobstructed grasping by the user.

Features, structures, and characteristics described in connection with any one or more of the above embodiments may be combined in any suitable manner in one or more embodiments. In addition, features described with respect to a particular embodiment may be omitted or replaced with other features without departing from the scope of the claimed subject matter.

### BRIEF DESCRIPTION OF THE DRAWINGS

FIG. 1 is a perspective view of an exemplary embodiment of an electrical conductor splice device according to the present disclosure.

FIG. 2 is a side view of the splice device of FIG. 1.

FIG. 3 is an exploded perspective view showing the components of the splice device of FIG. 1.

FIG. 4 is a section view of the splice device of FIG. 1.

FIG. 5A is a perspective view of a jaw of FIG. 1.

FIG. 5B is a perspective view of an alternate embodiment of the jaw of FIG. 1.

FIG. 5C is a perspective view of an alternate embodiment of the jaw of FIG. 1.

FIG. 5D is a perspective view of an alternate embodiment of the jaw of FIG. 1.

FIG. 6 is another section view of the splice device of FIG. 1 with an electrical conductor installed.

FIG. 7 is a partial side view of the splice device of FIG. 1 with an electrical conductor installed in a first position.

FIG. 8 is a partial side view of the splice device of FIG. 1 with an electrical conductor installed in a second position.

FIG. 9 is a section view of FIG. 8.

FIG. 10 is a perspective view of an exemplary embodiment of an electrical conductor splice device according to the present disclosure having the jaw of FIG. 5C.

FIG. 11 is a side view of the splice device of FIG. 10.

FIG. 12 is a perspective view of an exemplary embodiment of an electrical conductor splice device according to the present disclosure having the jaw of FIG. 5D.

FIG. 13 is a bottom view of the splice device of FIG. 12.

### DETAILED DESCRIPTION

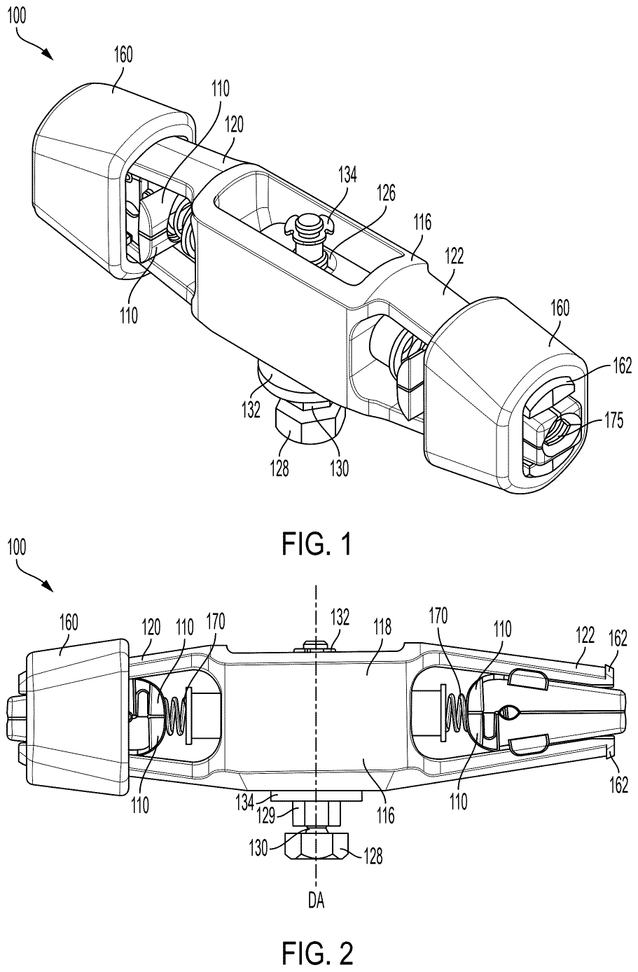

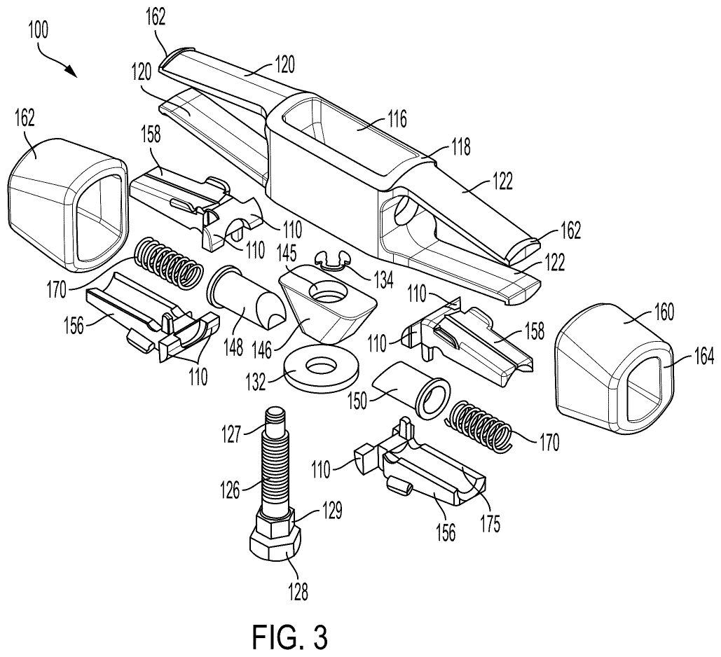

Referring to the drawings and, in particular, with simultaneous reference to FIGS. 1 to 5B, an exemplary embodiment of an electrical conductor splice device according to the present disclosure is shown and is generally referred to by reference numeral 100.

Device 100 is configured to electrically and mechanically connect electrical conductors to one another where the conductors are under tension or that have little or no tension applied to the conductors, commonly called slack-span conductors. Device 100 can be installed on the electrical conductors using common tightening tools such as, but not limited to, open-end wrenches, boxed-end wrenches, adjustable wrenches, manual socket wrenches, and impact wrenches.

Device 100 includes a removal tab 110 that allows an installer to remove an electrical conductor from the splice device without damaging the conductor, in situations, for example, where the conductor was improperly installed or requires adjustment, and/or in situations where the splice device needs to be replaced during initial installation.

Device 100 has a housing 116 that includes a hub 118 and a pair of legs 120, 122 that depend outward from the hub at about 180 degrees from one another. In some embodiments, housing 116 is formed as a single aluminum member with hub 118 and legs 120, 122 integral thereto. For example, device 100 can, in some cases, be formed as an aluminum casting that requires no post-casting machining.

In some embodiments, each of legs 120, 122 is structured to receive a cover 160 at a location remote from hub 118. Cover 160 encircles each pair of legs 120, 122. In FIG. 2, only one of covers 160 is shown. Cover 160 can have a tapered inner diameter (not shown) to facilitate assembly and positioning around legs 120, 122. Each of legs 120, 122 can have a ridge 162 against which an outer surface of cover 160 is seated to keep the cover in place once installed. In some embodiments, covers 160 cannot be removed once installed due to interference from ridge 162. In some embodiments, covers 160 can provide strength to legs 120, 122 to prevent the legs from deflecting outward and away from conductors when device 100 is tightened via a movement conversion assembly 124.

In some embodiments, covers 160 can bias legs 120, 122 slightly towards each other, for example, when an inner diameter of cover 160 is slightly less than an outer diameter around legs 120, 122.

Housing 116 receives a movement conversion assembly 124 within hub 118. Assembly 124 is configured to convert a tightening movement of a driver 126, which is illustrated by way of example as a bolt, into a clamping force on the conductors in the manner described in detail above with respect to device 100. Thus, certain parts performing similar or analogous functions to those of device 100 have been omitted for ease of discussion.

Driver 126, which is illustrated as a bolt with a head 128, is positioned so that applying a tightening torque to the driver via the head rotates the driver about a driver axis DA. In some embodiments, driver 126 includes a torque-limiting area 130 that shears off head 128 once an appropriate level of torque and, thus, a clamping force has been applied to device 100. In some embodiments, driver 126 can include a second head 129 that remains after shearing at torque limiting area 130 so that device 100 can be loosened or removed after an initial installation.

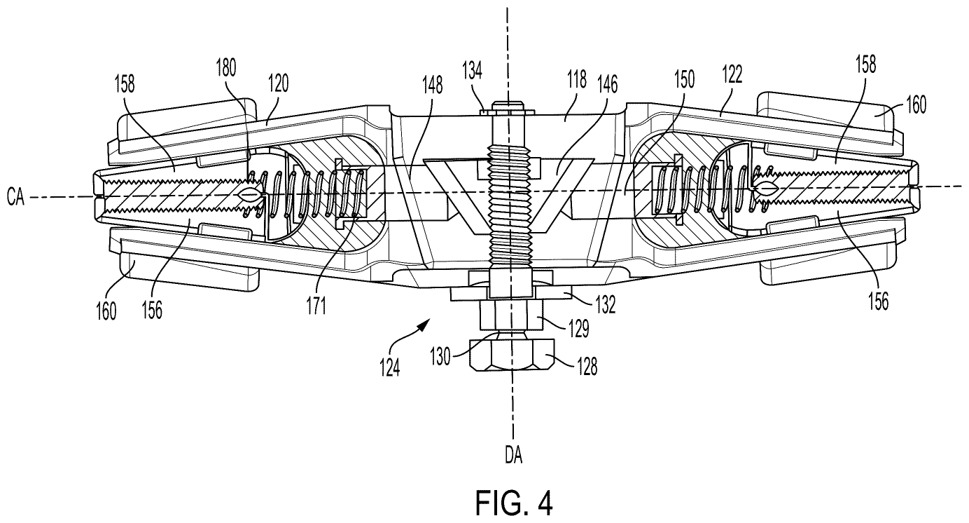

Assembly 124, best shown in FIG. 4, includes driver retaining structures 132, 134 on opposite sides of housing 116 that together allow driver 126 to rotate within the housing about driver axis DA but prevent the driver from moving linearly along the driver axis DA.

In the illustrated embodiment, driver retaining structure 132 on the side of housing 116 proximate head 128 is illustrated as a shoulder defined on driver 126 and a washer or bushing between hub 118 and the shoulder.

In the illustrated embodiment, driver retaining structure 134 on the side of housing 116 opposite head 128 is illustrated as a snap ring in a groove 127 on driver 126. Driver retaining structure 134 engages with a counterbore 145 of a driving wedge 146.

It should be recognized that driver retaining structures 132, 134 are illustrated by way of example only and that any retaining structure sufficient to secure assembly 124 in housing 116 in a manner that allows driver 126 to rotate within housing 116 but prevents the driver from moving linearly along the driver axis DA is contemplated by the present disclosure.

Assembly 124 further includes driving wedge 146 and a ram 148, 150 in each leg 120, 122. The driving wedges are threadably engaged with driver 126 so that the wedges move within hub 118 along driver axis DA during rotation of driver 126.

### Assembly 124 Includes One or More Jaws (two Shown) 156, 158 in Each Leg

120, 122.

Jaws 156, 158 are configured to move linearly along the conductor axis and are retained by one or more jaw retainers 161, 163 (two shown) that extend partially around legs 120, 122, respectively, to retain the jaws in the legs while guiding the jaws to move along the conductor axis CA.

Jaws 156, 158 also have a pair of removal tabs 110 projecting perpendicularly in opposite directions from a respective side face 112 away from the jaws. Removal tabs 110 are located at a proximate end of the respective jaws 156, 158, proximate hub 118, so that they are not enclosed by cover 160, when present.

Jaws 156, 158 are biased toward a default position. When a user applies force to removal tab 110, it moves against the biasing force, allowing controlled movement of the jaws and enabling them to separate.

Removal tabs 110 extend outward from jaws 156, 158, defining a protruding structure configured for grasping with fingers or a hand. Removal tab 110 has a proximal end integrally formed with or attached to the body of jaws 156, 158, and a distal end spaced apart therefrom. Removal tabs 110 have sufficient thickness and rigidity to provide structural support during user grasping and movement of jaws 156, 158 along the conductor axis CA, particularly while wearing personal protective equipment (PPE).

In some embodiments, removal tab 110 has a generally planar 113 or contoured 115 gripping surface sized to accommodate at least a portion of a user's fingers or palm.

In some embodiments, removal tabs 110 extend outward from a proximal end face 159 of one or more of jaws 156, 158 so that the removal tabs are perpendicular to the conductor axis CA and/or face hub 118 and stand proud of (e.g., are not flush with) legs 120, 122 and of cover 160, when present.

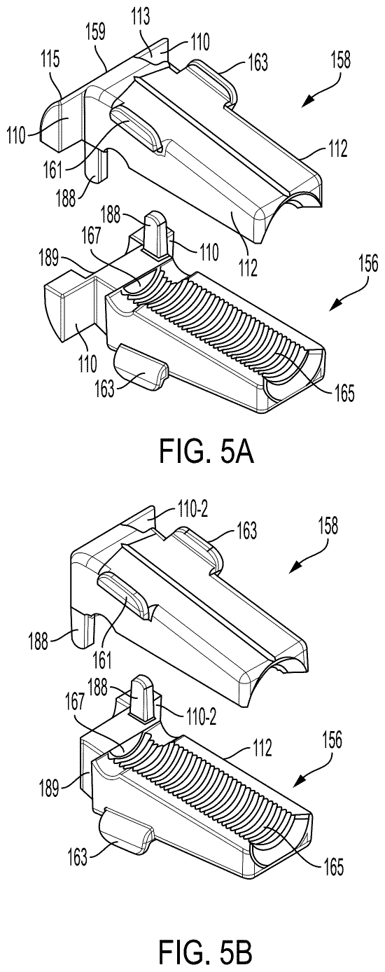

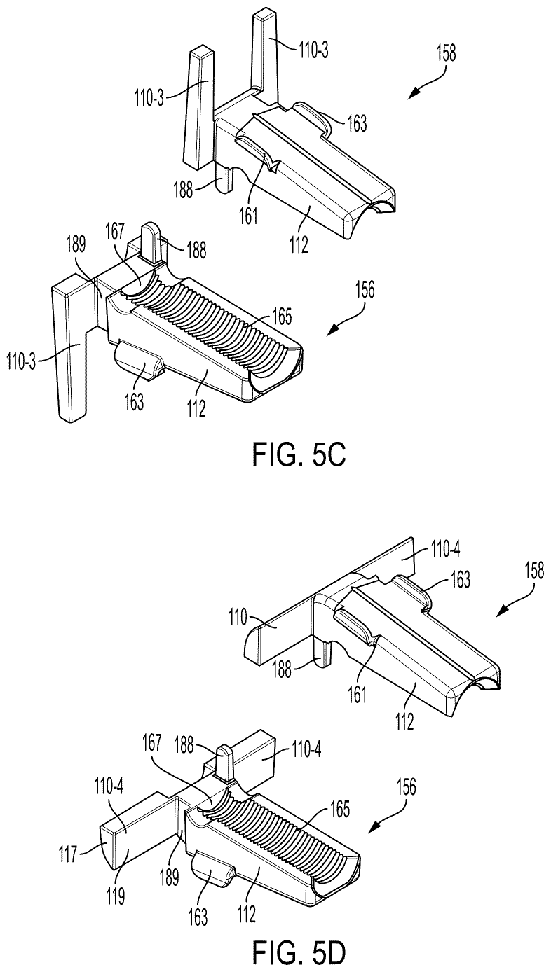

In other embodiments and as shown in FIG. 5B, the removal tabs 110-2 extend outward from a side face 112 of one or more of jaws 156, 158 so that the removal tabs are perpendicular to the conductor axis CA and/or face hub 118 and stand proud of (e.g., are not flush with) legs 120, 122 and of cover 160, when present. In these and/or other embodiments and in contrast to jaw retainers 161, 163 that extend partially around legs 120, 122, removal tabs 110-2 do not extend around and/or contact legs 120, 122.

In still other embodiments, and as shown in FIG. 5C, removal tabs 110-3 extend outward and downward from jaws 156, and outward and upward from jaws 158, each defining an L-shaped structure having an outward-extending portion and a downward-extending or upward-extending portion. The outward-extending portion projects perpendicularly from side face 112, but could also project at an angle (not shown), providing clearance from legs 120 and 122 and from cover 160, when present. In these and/or other embodiments and in contrast to jaw retainers 161, 163 that extend partially around legs 120, 122, removal tabs 110-3 do not extend around and/or contact legs 120, 122.

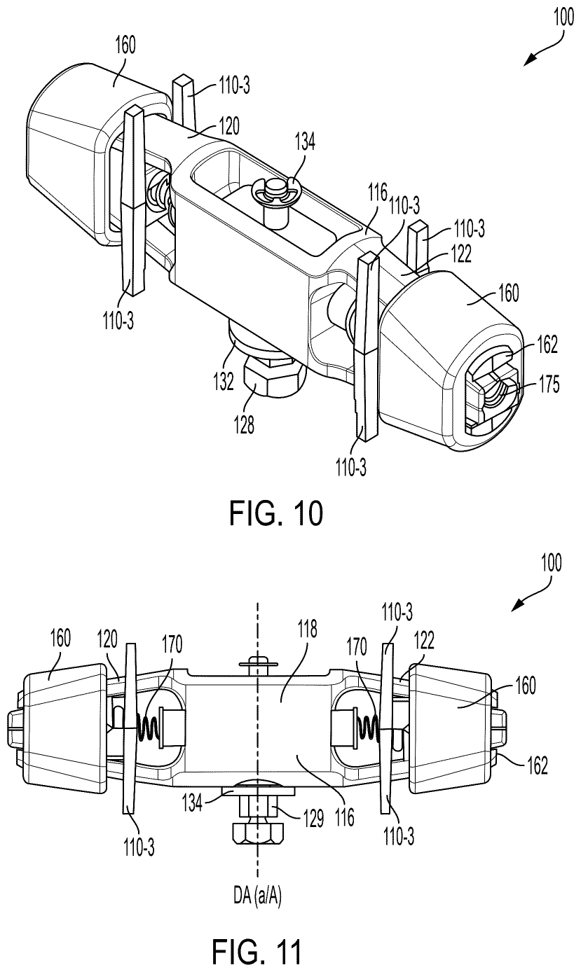

The downward-extending portion of jaw 156 and the upward-extending portion of jaw 158 are positioned generally perpendicular relative to the outward extension, but could be positioned at an oblique angle (not shown) relative to the outward extension. This configuration enables a user to grasp the downward portion from below, above, and/or from the respective sides of electrical conductor splice device 100, as shown in FIGS. 10 and 11. In some embodiments, when assembled, the downward-extending portion of jaw 156 and the upward-extending portion of jaw 158 form a coextending bar from a distal end of the downward-extending portion of jaw 156 to a distal end of the upward-extending portion of jaw 158 and are joined at the proximal end of the downward-extending portion of jaw 156 and the proximal upward-extending portion of jaw 158.

The respective downward-extending and upward-extending portions can have a textured or contoured gripping surface, such as ridges, grooves, or a rubberized coating, to improve friction and facilitate secure grasping.

In the embodiment shown in FIG. 5C, the downward-extending portion of jaw 156 and the upward-extending portion of jaw 158 are joined at respective ends to the outward-extending portion. In other embodiments, not shown, the outward-extending portion could extend further so that the removal tab 110 is T-shaped.

In some embodiments, a thickness of removal tab 110-3 is uniform, while in other embodiments, the thickness tapers.

In yet other embodiments and as shown in 5D, removal tabs 110-4 extend outward from a side face 112 of one or more of jaws 156, 158 so that the removal tabs are perpendicular to the conductor axis CA and/or face hub 118 and stand proud of (e.g., is not flush with) legs 120, 122 and of cover 160, when present. In these and/or other embodiments and in contrast to jaw retainers 161, 163 that extend partially around legs 120, 122, removal tabs 110-4 do not extend around and/or contact legs 120, 122.

Removal tabs 110-4 include a flat face 119 on one side and a curved surface 117 on the opposite side. Flat face 119 can be oriented to provide a stable, broad gripping surface that accommodates various grasping techniques. Curved surface 117 can be convex, concave, or partially tapered. A thickness of removal tab 110-4 is uniform throughout its length or varies along its profile to optimize strength and usability.

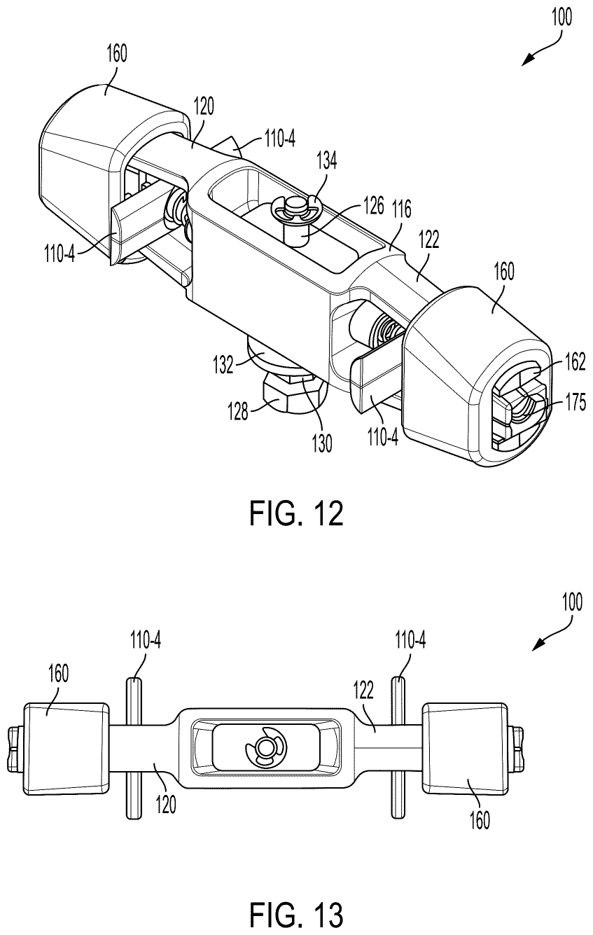

As can be seen in FIGS. 12 and 13, removal tabs 110-4 extend significantly, at least a finger's width, away from and clear of cover 160, so that the removal tabs can be grasped unimpeded by the cover.

In some embodiments that are not shown, removal tab 110 can include additional structural reinforcements, such as ribs, chamfers, or fillets, to improve durability and resistance to bending forces

Spacing between removal tabs 110 and cover 160 varies based on the presence or absence of a conductor between jaws 158, 156, and if present, the thickness of the conductor.

In these manners, removal tabs 110 are configured to enable an installer to manually move jaws 156, 158 along the conductor axis CA, and particularly to do so while cover 160, when present, is engaged and encircling a distal portion of the jaws away from hub 118.

It should be recognized that removal tabs 110 are illustrated by way of example only and that other removal tab structures projecting from jaws 156, 158 that are sufficient in size and shape for an installer to grasp and manually move the jaws along the conductor axis are contemplated by the present disclosure.

As shown in FIG. 5A-5D, jaws 156, 158 have a plurality of serrations 165 which function to grip the electrical conductor.

Jaws 156, 158 can also include cooperating synchronization features 188, 189. In the illustrated embodiments, feature 188 is shown as a protrusion, and feature 189 is shown as a corresponding indentation. In this manner, jaws 156, 158 are configured, when features 188 are received in features 189, to move in unison along conductor axis CA.

In some embodiments, as also shown in FIG. 5B, one or more of features 188 and 189 can have removal tab 1102 that extends from the side face 112 of one or more of jaws 156 and 158 in a direction perpendicular to the conductor axis CA. In this manner, the outward extension of the synchronization feature 188 defines removal tab 110-2.

Jaw retainers 161, 163, and features 188, 189 are integrally formed with jaws 156 and 158. For example, and in some embodiments, jaws 156, 158 are identical to one another and are formed as a single aluminum casting that requires no post-casting machining.

Device 100 further includes a biasing member 170 operably disposed between rams 148 and 150 and jaws 156 and 158. Biasing member 170 can be captured by spring lands 167 and 171 of the jaws and rams, providing a first degree of freedom that allows device 100 to accommodate conductors of differing outer diameters.

An exemplary assembly of device 100 will now be described. Assembly of device 100 begins with securing driver 126, driving wedge 146, and rams 148, 150 in each leg 120, 122 of housing 116. Jaw 156 is positioned in leg 120 with retainers 161, 163 around the lower portion of leg. With jaw 156 in this position, synchronization features 188, 189 are on opposite sides of leg 120.

Next, jaw 158 is positioned in leg 120, inverted with respect to jaw 156. In this position, retainers 161, 163 of jaw 158 are around the upper portion of leg 120. Since jaw 158 is inverted with respect to jaw 156, synchronization feature 188 of jaw 158 is received in synchronization feature 189 of jaw 156, and synchronization feature 189 of jaw 158 is received in synchronization feature 189 of jaw 156.

Device 100 is configured so that the shape and dimensions of legs 120, 122, and jaws 156, 158 are such that both jaws can be positioned in each of legs 120, 122, respectively. To assist with the installation of jaws 156 and 158, the jaws can be positioned proximate to hub 118.

Next, jaws 156 and 158 are moved within legs 120 outward (away) from hub 118 to provide a gap between the jaws and ram 148. Device 100 is configured so that biasing member 170 is compressible to a dimension smaller than the gap. In this manner, biasing member 170 can be positioned on the spring seats of ram 148 and jaws 156 and 158, respectively. Cover 160 is then slid over the outside of legs 120, which compress towards each other until the cover is in place and seated against ridge 162. Once biasing member 170 is released, the interaction of the biasing member, retainers 161, 163, cover 160, and synchronization features 188, 189 are sufficient to maintain jaws 156, 158 in the desired position within leg 120. These steps can then be repeated for leg 122.

In some embodiments, jaws 156 and 158, alone or in combination, are configured to define a window 180. When installing the conductors into device 100, window 180 provides the user with a visual indication that the conductors are properly positioned within jaws 156, 158, without the need to have previously measured and marked the conductor ends.

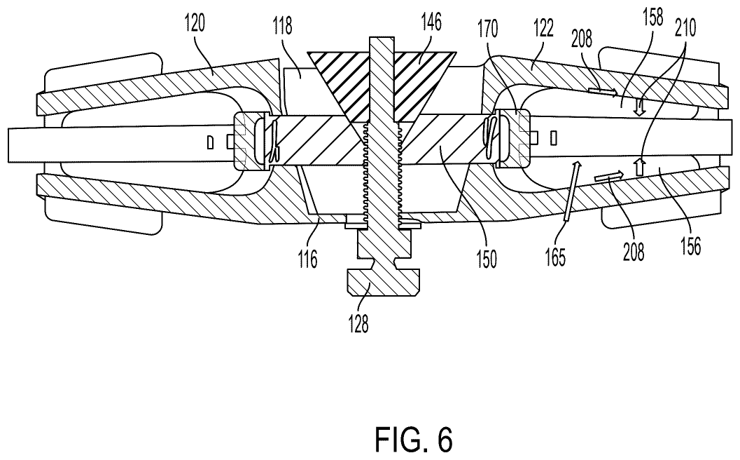

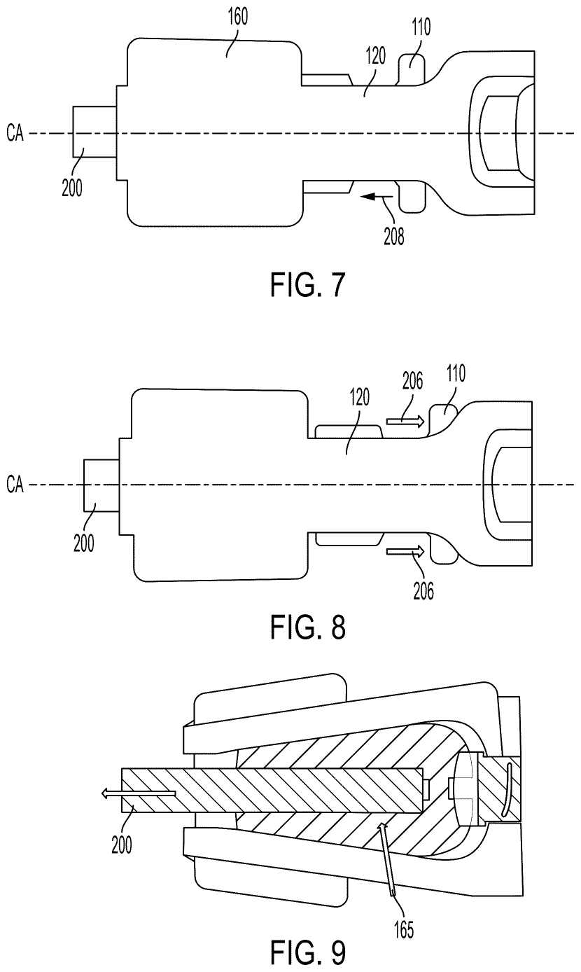

Reference is now made to FIGS. 6 to 10, which show the operation of device 100 with an electrical conductor.

Jaws 156, 158 have serrations 165 that, along with the angled surfaces of legs 120, 122 along which the jaws move, in the direction shown by arrows 208, force the jaws to compress conductor 200, in the direction shown by arrows 210. Without removal tab 110, it would be difficult, if not impossible, to remove conductor 200 once inserted.

Removal tab 110 allows an installer to move the wedged jaws 156, 158 in a direction opposite the spring force indicated by arrows 206, thus moving the serrations away from conductor 200, opposite arrows 210. In doing so, the conductor can be removed from jaws 156 and 158, adjusted, and reinserted as necessary for the installation.

It should also be noted that the terms “first”, “second”, “third”, “upper”, “lower”, and the like may be used herein to modify various elements. These modifiers do not imply a spatial, sequential, or hierarchical order to the modified elements unless specifically stated. Terms such as “upper,” “lower,” “left,” “right,” “front,” “rear,” “top,” and “bottom” are used for convenience of description and do not require a particular orientation unless expressly stated.

As used herein, when elements are described as being connected, coupled, or otherwise associated with one another, such description includes both direct and indirect relationships unless the context clearly indicates otherwise.

As used herein, the singular forms “a,” “an,” and “the” include plural referents unless the context clearly indicates otherwise. The phrase “one or more” means at least one and includes a plurality.

While the present disclosure has been described with reference to one or more exemplary embodiments, it will be understood by those skilled in the art that various changes can be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure shall not be limited to any particular embodiment disclosed as the best mode contemplated, but that the disclosure will include all embodiments falling within the scope of the appended claims.

### PARTS LIST

electrical conductor splice device 100 ridge 162
removal tab 110, 110-1, 110-2 jaw retainers 161, 163
housing 116 plurality of serrations 165
hub 118 biasing member 170
legs 120, 122 spring lands 167, 171
movement conversion assembly 124 window 180
driver 126 synchronization features 188, 189
groove 127 conductor 200
head 128 arrows 206
second head 129 arrows 208
torque limiting area 130 arrows 210
driver retaining structures 132, 134 driver axis DA
counterbore 145 conductor axis CA
driving wedge 146
ram 148, 150
jaws 156, 158
end face 159-1
side face 159-2
cover 160

What is claimed is:

1. An electrical conductor splice device, comprising:
a main housing having a hub and a first leg, the first leg depending outward from the hub along a conductor axis;
a first set of jaws positioned in the first leg, the first set of jaws being configured to receive a first electrical conductor;
a movement conversion assembly within the hub and including a driver, the movement conversion assembly being operatively associated with the first set of jaws to convert a tightening movement of the driver into movement of the first set of jaws along the conductor axis away from the hub;
wherein the first leg has an inner surface that engages an outer surface of the first set of jaws to convert the movement of the first set of jaws along the conductor axis into a clamping movement that imparts a first clamping force on the first electrical conductor to mechanically and electrically connect the first electrical conductor; and
a first tab projecting from at least one jaw of the first set of jaws;
wherein the first tab defines a protruding structure sized and positioned for grasping by a user while the first clamping force is applied, and
wherein application of a force to the first tab by the user enables movement of the at least one jaw along the conductor axis toward the hub to reduce the first clamping force and release the first electrical conductor.

2. The splice device of claim 1, wherein the tightening movement is a rotary movement of the driver about a driver axis or a linear movement of the driver along the driver axis.

3. The splice device of claim 1,
wherein the movement conversion assembly comprises a driving wedge and a first ram configured to convert the tightening movement into linear movement of the first ram along the conductor axis, and
wherein the linear movement of the first ram along the conductor axis results in movement of the first set of jaws along the conductor axis.

4. The splice device of claim 3, further comprising a first biasing member positioned between the first ram and the first set of jaws.

5. The splice device of claim 4, wherein the first biasing member is configured to provide an initial clamping force on the first electrical conductor prior to the tightening movement.

6. The splice device of claim 4, wherein the first set of jaws is biased toward a default position.

7. The splice device of claim 6, wherein application of a force to the first tab moves the at least one jaw against a biasing force to reduce the first clamping force.

8. The splice device of claim 1, wherein the first tab depends from the at least one jaw in a direction perpendicular to the conductor axis.

9. The splice device of claim 1, wherein the first tab depends from a side surface of the at least one jaw.

10. The splice device of claim 9, wherein the first tab does not surround and does not contact the first leg.

11. The splice device of claim 1, wherein the first set of jaws comprises synchronization features configured to operatively connect jaws of the first set of jaws to one another so as to move in unison along the conductor axis.

12. The splice device of claim 11, wherein the first tab depends from one of the synchronization features.

13. The splice device of claim 1, wherein the first tab is T shaped, L shaped, or linear.

14. The splice device of claim 1, wherein the main housing further comprises a second leg depending outward from the hub along the conductor axis, and the splice device further comprises:
a second set of jaws positioned in the second leg, the second set of jaws being configured to receive a second electrical conductor;
a second tab projecting from at least one jaw of the second set of jaws;
wherein the movement conversion assembly is operatively associated with the second set of jaws to convert the tightening movement of the driver into movement of the second set of jaws along the conductor axis away from the hub,
wherein the second leg has an inner surface that engages an outer surface of the second set of jaws to convert the movement into a clamping movement that imparts a second clamping force on the second electrical conductor to mechanically and electrically connect the second electrical conductor, and
wherein application of a force to the second tab enables movement of the at least one jaw of the second set of jaws along the conductor axis toward the hub to reduce the second clamping force and release the second electrical conductor.

15. The splice device of claim 14, wherein the movement conversion assembly is configured to move along the conductor axis during the tightening movement so as to accommodate differences in diameter of the first electrical conductor and the second electrical conductor.

16. The splice device of claim 14, wherein the first set of jaws and the second set of jaws move along the conductor axis independent of one another or in unison.

17. The splice device of claim 14,
wherein the movement conversion assembly comprises a driving wedge, a first ram, and a second ram configured to convert the tightening movement into linear movement of the first ram and the second ram along the conductor axis, and
wherein the linear movement of the first ram and the second ram results in movement of the first set of jaws and the second set of jaws, respectively.

18. The splice device of claim 17, further comprising:
a first biasing member positioned between the first ram and the first set of jaws; and
a second biasing member positioned between the second ram and the second set of jaws
wherein the first biasing member and the second biasing member are configured to provide an initial clamping force on the first electrical conductor and the second electrical conductor prior to the tightening movement.

19. The splice device of claim 1, further comprising:
a first cover disposed around the first leg to enclose a portion of the first set of jaws,
wherein the first tab is not enclosed by the first cover.

20. The splice device of claim 19, wherein the first tab extends clear of the first cover.
